(19) United States
(12) Patent Application Publication
(10) Pub. No.: US 2025/0250038 A1
(43) Pub. Date: Aug. 7, 2025

(54) SEALING APPARATUS, BARRIER SYSTEM AND METHOD

(71) Applicant: Groninger & Co. GmbH, Crailsheim (DE)

(72) Inventors: Armin MERZ, Ellwangen (DE); Roland ENGELHARD, Aurach-Weinberg (DE)

(21) Appl. No.: 19/188,110

(22) Filed: Apr. 24, 2025

Related U.S. Application Data
(63) Continuation of application No. PCT/EP2023/079509, filed on Oct. 23, 2023.

(30) Foreign Application Priority Data
Oct. 28, 2022 (DE) 10 2022 128 724.6

(51) Int. Cl. B65B 7/28; G01M 3/38

(52) U.S. Cl. CPC B65B 7/285; G01M 3/38

(57) ABSTRACT

A sealing apparatus for sealing a container, such as a pharmaceutical or cosmetic container, with a closure cap, where the sealing apparatus comprises a holding unit and a crimping unit. The holding unit is configured to hold the container at a crimping position, and the crimping unit is configured to crimp the closure cap onto the container at the crimping position. The sealing apparatus further comprises an optical inspection unit which is configured to inspect one or more properties of the container and/or the closure cap at the crimping position, and the inspection unit comprises a camera system. There is also disclosed a barrier system, such as an isolator system, and a method for sealing a container, like a pharmaceutical or cosmetic container, with a closure cap.

### CROSS-REFERENCE TO RELATED APPLICATIONS

This is a Continuation application of International patent application PCT/EP2023/079509, filed Oct. 23, 2023, which claims the priority of German patent application DE 10 2022 128 724.6, filed Oct. 28, 2022. Both application PCT/EP 2023/079509 and DE 10 2022 128 724.6 are herewith incorporated by reference in their entireties.

### FIELD

The present invention generally relates to a sealing apparatus for sealing a container, such as a pharmaceutical or cosmetic container, with a closure cap, to a barrier system, such as an isolator system, and to a method for sealing a container, such as a pharmaceutical or cosmetic container, with a closure cap.

### BACKGROUND

A barrier system is to be understood as a system that provides a physical and aerodynamic barrier, for example by means of positive air pressure, between an external environment, for example an external cleanroom environment, and a working process. In particular, a barrier system provides an environment with restricted access in which the working process can be carried out. Various barrier systems are known from the prior art. A barrier system may comprise, for example, an isolator or a restricted access barrier, a so-called RABS, “Restricted Area Barrier System”. The RABS may be an open RABS or a closed RABS.

The present disclosure primarily relates to aseptic isolators as barrier systems. However, the present disclosure may also be applied in other barrier systems, such as in an open or closed RABS.

The term “isolator” is generally to be understood as a container that is hermetically sealed and gas-tight with respect to the surrounding working area. Within an isolator, a defined atmosphere can be generated for processing sensitive or hazardous products.

In this context, isolators are usually used in biopharmaceutical process technology, for example as part of a filling system with multiple processing stations, to create a high-purity or sterile, i.e. germ-free, environment. In such filling systems, containers, for example vials, carpules, bottles, syringes and/or the like, can be filled with a product, for example a pharmaceutical or cosmetic product, in particular a liquid or a powder, and then sealed with a closure element, for example a stopper or a closure cap, preferably a crimp cap.

For handling the containers and/or the closure elements, one or more handling units, in particular handling robots, can be arranged in the isolator. For filling the containers, a filling station can be provided in the isolator. For sealing the containers, one or more sealing stations, for example a stoppering station and/or a crimping station, can be arranged in the isolator. In a sealing station, each container is sealed with a closure element after filling. In particular, a stopper can be placed onto the container in a stoppering station. In the crimping station, a closure cap can be placed on the container, in particular crimped. For sealing a container, a stopper can in particular first be placed onto or into an opening of the container. Then a closure cap can be placed onto the container and crimped, wherein the stopper is pressed against the mouth rim of the container by means of the closure cap in order to ensure proper sealing of the container.

To seal containers with a closure cap, the sealing station can comprise a sealing apparatus, such as a crimping apparatus. By means of this sealing apparatus, a closure cap, in particular a crimp cap, can be applied to a filled container, in particular crimped. Such sealing apparatuses are known from the prior art.

For example, document WO 2021/214809 A1 discloses an apparatus for filling containers with a powdery material comprising a supply station arranged to supply a plurality of containers; a filling station arranged downstream of the loading station and comprising a metering assembly configured to fill each container with a metered quantity of a powdery material; a sealing station arranged downstream of the filling station; and at least one handling assembly that is movable to transport at least one container from one station to a following station.

In filling systems, it is generally desirable to monitor the process steps. Various types of sensors can be used for this purpose. Optical sensors (such as cameras) are usually mounted on the ceiling or also outside the isolator behind a glass pane. Such optical sensors can be used, for example, to determine the position of objects within the isolator and to control handling units accordingly. Other sensors, such as light barriers and pressure or force sensors, are preferably provided in individual processing stations in order to detect process parameters directly in the processing stations.

Especially when filling and sealing cosmetic or pharmaceutical products, it is important that the filled container is properly sealed. For this purpose, an inspection can be carried out, for example, in the sealing apparatus or downstream of the sealing apparatus. For example, it is known to determine by means of a force sensor or a position sensor whether the closure cap has been properly crimped onto the containers.

For example, document US 2009/020496 A1 discloses a system and a method for validating the crimping of a vial with a stopper and a cap. The system comprises a crimping cylinder, a controller that validates the crimping of the cap onto the vial, and an indicator for indicating whether the crimping has been validated. The crimping cylinder comprises a piston; several crimping jaws that interact with the piston, wherein the crimping jaws move into a closed position when the piston is moved downward, and the crimping jaws move into an open position when the piston is moved upward; a position indicator; and a position sensor. The position indicator and the position sensor indicate a position of the piston.

Furthermore, document EP 1 955 949 A1 discloses a machine for filling and sealing containers. The machine comprises: a conveyor actuated stepwise in a feed direction, which is laterally provided with a plurality of gripping devices that can carry containers at an active branch of a conveyor to which a main gas stream of a sterile substance is applied; a filling station in which a plurality of nozzles operate for batchwise filling of the containers located therebelow, and weighing elements operate for detecting that a correct filling of the containers has been achieved; a sealing station in which sealing members that enable the sealing of the containers with closure caps, and sensors that are capable of detecting a correct sealing of the containers by the sealing members, operate; a release station downstream of the sealing station, in which manipulator members operate, wherein the manipulator members are kept deactivated in order to allow the transport of containers in which faulty filling and/or sealing parameters have been detected, wherein these containers are released onto a reject conveyor located downstream and in line with the active branch; or wherein the manipulator members are activated transversely to the feed direction in order to collect the containers handed over with correct filling and sealing parameters and to discharge them onto a discharge conveyor which is arranged adjacent and parallel to the reject conveyor.

Furthermore, document DE 10 2020 117 790 A1 discloses a device for testing the tightness of a closure of a container, in particular a pharmaceutical or cosmetic container, which comprises a closure cap for sealing the container and an elastic sealing element which is arranged between the closure cap and a mouth rim of the container, comprising: a rotary plate movable relative to the closure of the container for applying a pressure force to the elastic sealing element in order to cause a compression of the elastic sealing element, wherein the rotary plate is connected to an axially displaceable drive shaft of a drive unit, and wherein the rotary plate is configured to be rotated together with the container coupled thereto; a crimping unit for crimping the closure cap; a control unit for controlling the drive unit; and a position sensor for providing a value representing a stroke position of the rotary plate.

However, the known sealing apparatuses and methods for sealing a container with a closure cap still leave room for improvement, particularly with regard to the inspection of the sealing process.

### SUMMARY

Against this background, it is an object of the present disclosure to provide an improved sealing apparatus, an improved barrier system, in particular an isolator system, and an improved method for sealing a container with a closure cap, in particular in which the inspection of the sealing process is improved.

According to a first aspect, a sealing apparatus for sealing a container, in particular a pharmaceutical or cosmetic container, with a closure cap is provided, wherein the sealing apparatus comprises a holding unit and a crimping unit, wherein the holding unit is configured to hold the container at a crimping position, and wherein the crimping unit is configured to crimp the closure cap onto the container at the crimping position, wherein the sealing apparatus further comprises an optical inspection unit which is configured to inspect one or more properties of the container and/or of the closure cap at the crimping position, wherein the inspection unit comprises a camera system.

According to a second aspect, a barrier system is provided, wherein the barrier system comprises an environment with restricted access, in particular an isolator, and the sealing apparatus according to the first aspect. The sealing apparatus may in particular be arranged within the environment with restricted access. The barrier system may in particular be an isolator system, wherein the environment with restricted access is an isolator. Alternatively, the barrier system may also be an open or closed RABS.

According to a third aspect, a method for sealing a container, in particular a pharmaceutical or cosmetic container, with a closure cap is provided, the method comprising the following steps:
holding the container at a crimping position by means of a holding unit of a sealing apparatus;
crimping the closure cap onto the container at the crimping position by means of a crimping unit of the sealing apparatus; and
inspecting one or more properties of the container and/or of the closure cap at the crimping position by means of an optical inspection unit of the sealing apparatus, wherein the inspection unit comprises a camera system.

The method according to the third aspect may preferably be carried out by means of the sealing apparatus according to the first aspect and in particular in the isolator system according to the second aspect.

The sealing apparatus is preferably a crimping apparatus, wherein the closure cap is preferably a crimp cap. The container is preferably a vial, an ampoule, or the like, which may be filled with a pharmaceutical or cosmetic product. The closure cap can be placed onto the container. In other words, the container can be arranged or provided at the crimping position for sealing with the closure cap placed thereon. In particular, the container may comprise an opening in which a stopper is arranged, wherein the closure cap is placed onto the container in such a way that it surrounds the opening and the stopper.

The sealing apparatus comprises the holding unit and the crimping unit for sealing the container. In particular, the sealing apparatus may comprise a support structure that carries the holding unit and the crimping unit. The holding unit serves to hold the container at the crimping position. The crimping unit serves to crimp the closure cap onto the container at the crimping position. The crimping position is a specific position in space at which the container is arranged for crimping. The crimping position may preferably be a position within the environment with restricted access at which the container is arranged for crimping.

By crimping, the closure cap is fastened to the container. For this purpose, the container may comprise a crimping region. The closure cap may preferably be crimped in the crimping region of the container. When the closure cap is placed on the container, it may extend from the opening to the crimping region. By crimping, the closure cap is pressed against or into the crimping region in the area of the crimping region. The crimping region may comprise, for example, a recess, a depression, or a groove. The crimping region preferably extends circumferentially around the container. Preferably, the crimping region may be arranged at or below the opening.

Preferably, the container is arranged at the crimping position with a closure cap placed thereon. In particular, the closure cap may be placed onto the container prior to sealing, for example by means of one of the handling units of the barrier system. In particular, the container may already be fed to the sealing apparatus with the closure cap placed thereon. Alternatively, the closure cap may be placed onto the container only in the sealing apparatus prior to sealing. At the crimping position, the container may then be held together with the placed closure cap by means of the holding unit. The crimping unit may then crimp the closure cap onto the container while the container with the placed closure cap is being held.

The barrier system, in particular the isolator system, may preferably be part of a filling system with multiple processing stations. The processing stations may be arranged in the environment with restricted access of the barrier system. The filling system may be, for example, a system for filling and sealing containers with a pharmaceutical or cosmetic substance. In the filling system, the containers are filled in the filling station and then sealed with a closure cap in the sealing station. For this purpose, the filling system may comprise a filling station and a sealing station and optionally a stoppering station. The filling station and the sealing station may be arranged within the environment with restricted access. The sealing apparatus may be part of this sealing station. Prior to sealing in the sealing station, a stopper may be placed onto filled containers in the stoppering station.

The barrier system may further comprise one or more handling units in the environment with restricted access. By means of the handling units, containers and closure caps can be handled. For example, one of the handling units may transfer filled containers from the filling station or the stoppering station to the sealing station. Furthermore, one of the handling units in the sealing station may also place a closure cap onto the container. The placed closure cap may then be crimped onto the container at the crimping position by means of the crimping unit.

The environment with restricted access is preferably an isolator. The isolator may comprise an interior space. The isolator is preferably an aseptic isolator. An aseptic isolator comprises a high-purity or sterile, i.e. germ-free, environment in the interior space. The sealing apparatus may be arranged in the isolator, in particular in the interior space of the isolator. Furthermore, the filling station and/or the stoppering station and/or the one or more handling units may also be arranged in the isolator.

The barrier system may further comprise a control unit. The control unit may be configured, for example, to control devices such as the sealing apparatus and/or one or more handling units within the environment with restricted access.

According to the disclosure, the sealing apparatus comprises an optical inspection unit. The inspection unit serves for optical inspection or monitoring of the sealing process. At the crimping position, the inspection unit may in particular optically inspect the container and/or the closure cap placed onto the container and/or optionally the stopper placed onto the container. The optical inspection is carried out by means of the camera system of the inspection unit. In particular, the inspection unit inspects one or more properties of the container and/or of the closure cap. The properties of the container may comprise, for example, a configuration and/or an arrangement of the container. The configuration of the container may comprise, for example, a shape, a size, a color, a surface texture and/or a surface profile of the container. The arrangement of the container may comprise, for example, a position and/or an orientation of the container. The properties of the closure cap may comprise a configuration and/or an arrangement of the closure cap, in particular on the container. The configuration of the closure cap may comprise, for example, a shape, a size, a color, a surface texture and/or a surface profile of the closure cap. The arrangement of the closure cap may comprise, for example, a position and/or an orientation of the closure cap.

Since the sealing apparatus comprises the optical inspection unit, the inspection unit is integrated in the sealing station. In particular, this allows an optical in-process inspection of the sealing process. For this purpose, the inspection unit may inspect one or more properties of the container and/or of the closure cap during the sealing process.

In particular, the inspection unit can inspect whether the container and the closure cap are arranged at the crimping position. For this purpose, the inspection unit can inspect, for example, the position of the container and the closure cap. Furthermore, the inspection unit can also inspect whether the correct container and/or the correct closure cap are arranged at the crimping position. For this purpose, the inspection unit can inspect, for example, the shape, the size and/or the color of the container and/or of the closure cap. Furthermore, the inspection unit can also inspect whether the closure cap is correctly placed onto the container. For this purpose, the inspection unit can inspect, for example, the position and/or the orientation of the closure cap. Furthermore, the inspection unit can also inspect whether the container has been properly sealed. In particular, the inspection unit can inspect the crimping quality for this purpose. For this purpose, the inspection unit can inspect, for example, the shape, the position and the orientation of the closure cap, preferably after crimping. In particular, the inspection unit can inspect whether the crimping of the closure cap is circumferentially uniform and/or whether the closure cap is arranged at a specific position after crimping.

On the basis of the optical inspection by the inspection unit, the control unit of the barrier system can in particular control the sealing apparatus and/or the handling units accordingly. For example, the control unit can control the sealing apparatus on the basis of the optical inspection in such a way that the sealing apparatus performs the crimping only for closure caps that are correctly placed onto a container. Furthermore, the control unit can cause a container that was found to be improperly sealed by the inspection to be transferred to a discharge unit by means of one of the handling units in order to discharge the improperly sealed container or collect it in a collection container.

In other words, according to the disclosure, an inspection unit with a camera system is integrated in the sealing apparatus, wherein the container and the closure cap are inspected. In particular, the sealing process in the sealing apparatus can be optically monitored and inspected by means of this inspection unit. The optical inspection of sealed containers has not been carried out in the sealing apparatus in previous solutions, but only in subsequent stations, for example by means of a camera system with several cameras imaging the container from different viewing angles, or in separate inspection machines downstream in the production process. By means of the inspection unit according to the disclosure, the inspection takes place directly and immediately in the sealing apparatus. In this way, the inspection of the sealing process is improved.

In a first refinement of the aspects, the inspection unit may further be configured to inspect one or more properties of a stopper which is arranged in an opening of the container.

The stopper may be a rubber stopper. The stopper may be inserted into the opening of the container. The container may in particular be provided with the stopper inserted, in particular arranged at the crimping position. The properties of the stopper may comprise a configuration and/or an arrangement of the stopper, in particular on the container. The configuration of the stopper may comprise, for example, a shape, a size, a color, a surface texture and/or a surface profile of the stopper. The arrangement of the stopper may comprise, for example, a position and/or an orientation of the stopper. In this way, an inspection of the stopper can also be carried out. The inspection of the stopper may in particular be carried out before the closure cap is placed onto the container. For example, it can be inspected whether the stopper is correctly arranged on the container. In particular, the container can be provided at the crimping position with the stopper inserted but without the closure cap. Then the inspection of the stopper can be carried out. After this inspection, the closure cap can be placed onto the container, for example by means of a handling unit of the barrier system. Then the crimping can be performed.

In a further refinement of the aspects, the holding unit may be configured to rotate the container about a vertical axis at the crimping position, in particular while the crimping unit crimps the closure cap onto the container and/or the inspection unit inspects the one or more properties of the container and/or of the closure cap at the crimping position.

In particular, the holding unit can rotate the container when the closure cap is arranged or placed onto the container and/or when the stopper is arranged or inserted in the opening of the container. In other words, the container can be rotated together with the stopper and/or the closure cap. In particular, the container can be rotated together with the placed closure cap while the crimping unit crimps the closure cap. By rotating the container and the closure cap during crimping, the closure cap is crimped circumferentially. Furthermore, the container, in particular together with the stopper and/or the closure cap, can be rotated while the inspection unit performs the inspection. By rotating the container during the inspection, the camera system can capture different areas of the container, the closure cap and/or the stopper.

In a further refinement of the aspects, the holding unit may comprise a receiving element for receiving the container.

The receiving element serves to receive the container. The receiving element may be configured, for example, as a rotary plate or turntable with a receptacle for a container. A container received in the receiving element is arranged at the crimping position. In this way, the container can be easily arranged at the crimping position.

In a further refinement of the aspects, the holding unit may comprise a counter element, wherein the container is arrangeable at the crimping position between the receiving element and the counter element, in particular wherein the receiving element and the counter element are spaced apart from one another in a vertical direction.

The counter element may preferably be arranged above the receiving element in the vertical direction. In particular, the container with the placed closure cap can be held between the receiving element and the counter element. In this way, the container with the closure cap can be easily arranged and held at the crimping position.

In a further refinement of the aspects, the holding unit may further comprise a drive unit for rotatory and/or translatory movement of the receiving element and/or of the counter element, in particular wherein the drive unit is configured to move the receiving element and/or the counter element in a vertical direction and/or to rotate it about a vertical axis.

The drive unit can move the receiving element and/or the counter element translationally, for example, in order to change the distance between the receiving element and the counter element. For example, the distance can be reduced in order to hold the container between the receiving element and the counter element. The translatory movement preferably takes place in the vertical direction. The movement in the vertical direction may also be referred to as a lifting movement. The drive unit can also move the receiving element and/or the counter element rotatory in order to change the arrangement of the container and the closure cap placed thereon relative to the camera system and/or to achieve a circumferentially uniform crimping during the crimping process. The rotatory movement preferably takes place about a vertical axis.

In a further refinement of the aspects, the drive unit may be configured to move the receiving element and the counter element relative to one another between a first arrangement and a second arrangement, wherein the container is receivable in the receiving element in the first arrangement, wherein the container is holdable in the second arrangement between the receiving element and the counter element at the crimping position.

In other words, the drive unit can adjust the distance between the receiving element and the counter element. In the first arrangement, the container, in particular with the closure cap placed thereon, can be received in the receiving element. In the first arrangement, the container and the closure cap can be spaced apart from the counter element. The first arrangement thus serves for receiving the container. In the second arrangement, the receiving element is arranged closer to the counter element than in the first arrangement. In the second arrangement, the container with the placed closure cap can be pressed against the counter element. In this way, the container is held together with the placed closure cap at the crimping position. The second arrangement thus serves for holding the container at the crimping position. The crimping preferably takes place when the container is held in the second arrangement. In particular, the closure cap can be pressed against the container, in particular against the stopper arranged in the opening, with a defined force in the second arrangement. This ensures that the container is tightly sealed.

In a further refinement of the aspects, the drive unit may be configured to rotate the receiving element and/or the counter element about a vertical axis, in particular while the crimping unit crimps the closure cap onto the container.

In particular, the drive unit may be configured to rotate the receiving element about a vertical axis when the container with the placed closure cap is received in the receiving element and thus arranged at the crimping position. The rotation takes place in particular when the receiving element and the counter element are arranged in the second arrangement. The drive unit can rotate the receiving element, for example, about the vertical axis. The counter element can then be rotatably mounted about the vertical axis. When a container is held between the receiving element and the counter element and the receiving element is rotated, the counter element is co-rotated. Alternatively, the drive unit can also rotate the counter element about the vertical axis. The receiving element can then be correspondingly rotatably mounted about the vertical axis. Alternatively, the drive unit can also rotate the receiving element and the counter element simultaneously about the vertical axis. By rotating the receiving element and/or the counter element during crimping, the closure cap is crimped circumferentially.

In a further refinement of the aspects, the crimping unit may comprise a crimping element, wherein the crimping element is movable into a working position in which the crimping element is pressed against the closure cap.

The crimping element may in particular be movable, in particular pivotable, between a working position and a waiting position. The crimping unit may comprise, for example, a drive unit which is configured to move the crimping element between the working position and the waiting position. In the working position, the crimping element is pressed against the closure cap for crimping. The working position thus serves for crimping the closure cap. In the waiting position, the crimping element is arranged spaced apart from the closure cap. The crimping element may preferably be a crimping disk or a crimping roller. The crimping element may be rotatably mounted about a, preferably vertical, axis.

In a further refinement of the aspects, the inspection unit may be configured to inspect the arrangement of the closure cap and/or of the container and/or of the stopper at the crimping position.

Holding or crimping at the crimping position is preferably to be performed only if the container with the placed closure cap is arranged at the crimping position. The inspection unit can inspect whether the container is arranged at the crimping position. Furthermore, the inspection unit can inspect whether the stopper is arranged on the container at the crimping position. Furthermore, the inspection unit can inspect whether the closure cap is arranged on the container at the crimping position. Preferably, the holding unit and the crimping unit are controlled in such a way that they perform holding and crimping only if the container and the closure cap, in particular the container with inserted stopper and with placed closure cap, are arranged at the crimping position. Furthermore, the inspection unit can inspect whether the container and/or the stopper and/or the closure cap are correctly arranged at the crimping position. For this purpose, for example, it can be determined whether the arrangement of the container and/or of the stopper and/or of the closure cap corresponds to a predetermined arrangement. If the closure cap and/or the container and/or the stopper are not correctly arranged at the crimping position, this can result in faulty crimping of the closure cap or faulty sealing of the container. The inspection unit can in particular inspect the arrangement of the closure cap and/or of the container and/or of the stopper at the crimping position before crimping or before holding. Preferably, the holding unit and the crimping unit are controlled in such a way that they perform holding and crimping only if the container, the stopper, and the closure cap are correctly arranged at the crimping position.

In a further refinement of the aspects, the inspection unit may be configured to inspect the configuration of the closure cap and/or of the container and/or of the stopper at the crimping position.

In particular, the inspection unit can inspect whether the correct container and/or the correct stopper and/or the correct closure cap are arranged at the crimping position. For this purpose, the inspection unit can compare the configuration of the container and/or of the stopper and/or of the closure cap with a predetermined configuration. For example, the inspection unit can compare the shape, size, and/or color of the container and/or of the stopper and/or of the closure cap with a predetermined shape, size, or color. A marking, such as a code, can also be applied to the container and/or the stopper and/or the closure cap, by means of which the container, the stopper, and the closure cap can be identified by the inspection unit. The code may be, for example, a Data Matrix code. The Data Matrix code may in particular be arranged or printed on a cap skirt of the closure cap. The inspection of whether the correct container and/or the correct stopper and/or the correct closure cap are arranged at the crimping position is preferably carried out before holding and/or crimping. Furthermore, the inspection unit can inspect whether the container and/or the stopper and/or the closure cap have a defect, such as a crack, a dent, or a scratch. This inspection can be performed before holding and/or crimping or also after holding and/or crimping. Furthermore, the inspection unit can inspect whether the closure cap has been correctly crimped onto the container. For this purpose, the inspection unit can inspect, for example, the shape of the closure cap. In particular, the inspection unit can inspect whether the closure cap has been correctly crimped onto the container. For this purpose, the inspection unit can inspect whether the crimping is circumferentially uniform and/or whether a lower edge of the crimped wall of the closure cap runs circumferentially at the same height, i.e., linearly. This inspection can be carried out during or after crimping.

In a further refinement of the aspects, the inspection unit may be configured to inspect the crimping quality of the crimping, in particular wherein the inspection unit is configured to inspect the crimping quality during or after crimping.

The crimping quality describes how well the closure cap is crimped onto the container. In particular, the crimping quality can describe whether the container is properly sealed with the closure cap. In particular, the inspection unit can determine whether the closure cap is arranged on the container in a predetermined position, in particular a position and/or orientation, after crimping. If the closure cap is not arranged in the specific position, the container is improperly sealed. In other words, the crimping quality is poor. Furthermore, the inspection unit can also determine whether the shape of the closure cap in the crimping region of the container corresponds to a predetermined shape. The closure cap is deformed in the crimping region of the container by crimping. The deformation should be as uniform as possible. In particular, it can be determined whether the crimping of the closure cap in the crimping region is circumferentially uniform. If the shape of the closure cap in the crimping region of the container does not correspond to the predetermined shape, in particular if the crimping in the crimping region is not uniform, the container is improperly sealed. If the arrangement of the closure cap and/or the shape of the closure cap in the crimping region corresponds to the predetermined arrangement or shape, the container is properly sealed. The crimping quality is then good. In this way, it can be optically inspected by means of the inspection unit whether the crimping quality is good or sufficient, in particular whether the container is properly or correctly sealed. Containers that are improperly crimped or improperly sealed can then be discharged or sorted out in the barrier system downstream of the sealing apparatus. For example, one of the handling units can transfer improperly sealed containers to a collection container.

In a further refinement of the aspects, the camera system may comprise one or more cameras which are configured to capture or record one or more images of the closure cap and/or of the container and/or of the stopper at the crimping position, wherein the inspection unit is configured to inspect, on the basis of the one or more images, the one or more properties of the container and/or of the closure cap and/or of the stopper.

Each camera captures at least one image of the container and/or of the closure cap at the crimping position. Each camera can also capture several images of the container and/or of the closure cap at the crimping position. These images are preferably recorded in temporal succession, in particular at regular time intervals, preferably during sealing of the container. The optical inspection is then carried out on the basis of the captured images.

In a further refinement of the aspects, the inspection unit may be configured to determine, on the basis of the one or more images, whether the container and/or the closure cap and/or the stopper are arranged at the crimping position, preferably in a predetermined arrangement.

The inspection unit can determine in particular on the basis of the captured images whether the container and the closure cap are arranged at the crimping position and/or whether the container and the closure cap are correctly arranged at the crimping position, preferably in a predetermined arrangement. For this purpose, the inspection unit can evaluate the captured images, for example.

In a further refinement of the aspects, the inspection unit may be configured to determine, on the basis of the one or more images, whether the configuration of the container and/or of the stopper and/or of the closure cap corresponds to a predetermined configuration.

The inspection unit can in particular inspect whether the correct container and/or the correct stopper and/or the correct closure cap are arranged at the crimping position. Furthermore, the inspection unit can inspect whether the container and/or the stopper and/or the closure cap have a defect. Furthermore, the inspection unit can inspect whether the closure cap has been correctly crimped onto the container. To inspect the configuration of the container and/or of the stopper and/or of the closure cap, the inspection unit can evaluate the captured images, for example.

In a further refinement of the aspects, the inspection unit may be configured to determine, on the basis of the one or more images, the crimping quality of the crimping, in particular wherein the inspection unit is configured to inspect the crimping quality during or after crimping.

In particular, the inspection unit can determine on the basis of the captured images whether the container is properly sealed with the closure cap or whether the crimping is proper. For example, it can be determined whether the closure cap is correctly arranged on the container and whether the crimping is circumferentially uniform. For this purpose, the inspection unit can evaluate the captured images, for example.

In a further refinement of the aspects, a camera of the camera system may be configured to successively capture a plurality of images of the closure cap and/or of the container at the crimping position while the holding unit rotates the container at the crimping position about the vertical axis, wherein the inspection unit is configured to inspect, based on the plurality of images, the one or more properties of the container and/or of the closure cap and/or of the stopper, in particular wherein the inspection unit is configured to determine, based on the plurality of images, the configuration of the closure cap and/or of the container and/or of the stopper, in particular the crimping quality of the crimping.

In other words, the camera system captures the plurality of images while the container is rotated at the crimping position by means of the holding unit. The images thus show different sections of the container and the closure cap. In particular, the captured images can be used to completely detect the circumferential crimped area of the closure cap. Based on the captured images, it can then be determined whether the crimping is circumferentially uniform. In this way, the crimping quality can be determined directly during the crimping process. The images can also be assembled into a continuous image that depicts the unrolled circumference of the closure cap, wherein the inspection unit evaluates the continuous image in order to determine the crimping quality.

In a further refinement of the aspects, the camera system may be arranged laterally adjacent to the crimping position.

The camera system, in particular the camera of the camera system, is preferably arranged at approximately the same height in the vertical direction as the crimping position. The camera system is preferably arranged at a horizontal distance from the crimping position. The image plane of the camera is preferably aligned parallel to the vertical direction. In other words, the viewing direction of the camera may preferably be perpendicular to the vertical direction. In particular, the camera system, in particular the camera of the camera system, may be arranged adjacent to the crimping unit and/or the holding unit. The crimping region of the container is preferably also arranged vertically. The crimping region can therefore be particularly well detected in this refinement.

In a further refinement of the aspects, the sealing apparatus may comprise a plurality of holding units and a plurality of crimping units, wherein each holding unit is configured to hold one container at a respective crimping position, wherein each crimping unit is configured to crimp one closure cap onto the respective container at the respective crimping position, and wherein the optical inspection unit is configured to inspect each container and/or each closure cap and/or each stopper at the respective crimping position, in particular wherein the camera system comprises a plurality of cameras, wherein each camera is configured to capture one or more images of the closure cap and/or of the container and/or of the stopper at a respective crimping position, wherein the inspection unit is configured to inspect each container and/or each closure cap and/or each stopper based on the one or more images of the cameras.

Preferably, the sealing apparatus is designed to simultaneously seal two containers, each with a closure cap. For this purpose, the sealing apparatus may comprise two holding units and two crimping units, which each hold a respective container at a respective crimping position and crimp the respective closure cap onto the container. The camera system may comprise two cameras, each camera being assigned to a crimping position and capturing one or more images of the container and the closure cap that are arranged at the respective crimping position. The camera system is preferably arranged between the two holding units.

In a further refinement of the aspects, the inspection unit may be configured to inspect, in the step of inspecting, one or more properties of a stopper that is arranged in an opening of the container.

As previously described, this also allows inspection of the stopper to be carried out.

In a further refinement of the aspects, the method may comprise the following step:
rotating the container at the crimping position by means of the holding unit about a vertical axis, in particular while the crimping unit crimps the closure cap onto the container and/or the inspection unit inspects the one or more properties of the container and/or of the closure cap at the crimping position.

In particular, the holding unit can rotate the container when the closure cap is arranged or placed on the container and/or when the stopper is arranged or inserted in the opening of the container. In other words, the container can be rotated together with the stopper and/or the closure cap. In particular, the container can be rotated together with the placed closure cap while the crimping unit crimps the closure cap. By rotating the container and the closure cap during crimping, the closure cap is crimped circumferentially. Furthermore, the container, in particular together with the stopper and/or the closure cap, can be rotated while the inspection unit performs the inspection. By rotating the container during inspection, the camera system can capture different areas of the container, the closure cap and/or the stopper.

In a further refinement of the aspects, the camera system may comprise one or more cameras, wherein the one or more cameras capture one or more images of the closure cap and/or of the container and/or of the stopper at the crimping position, wherein the inspection unit inspects, based on the one or more images, the one or more properties of the container and/or of the closure cap and/or of the stopper.

Each camera captures at least one image of the container and/or of the closure cap at the crimping position. Each camera may also capture several images of the container and/or of the closure cap at the crimping position. These images are preferably captured in temporal succession, in particular at regular time intervals, preferably during sealing of the container. The optical inspection is then carried out on the basis of the captured images.

It is understood that the features mentioned above and those yet to be explained below can be used not only in the respective combinations indicated, but also in other combinations or in isolation, without departing from the scope of the present invention.

### DRAWINGS

Embodiments of the disclosure are illustrated in the drawings and are explained in more detail in the following description. In the drawings:

FIG. 1 is an isometric view of an embodiment of a sealing apparatus;

FIG. 2 is an isometric view of a rear side of the sealing apparatus from FIG. 1;

FIG. 3 is a top view of a front side of the sealing apparatus from FIG. 1;

FIG. 4 is a top view of an upper side of the sealing apparatus from FIG. 1;

FIG. 5 is an isometric view of the sealing apparatus from FIG. 1 without an inspection unit;

FIG. 6 is a top view of a front side of the sealing apparatus from FIG. 1 without an inspection unit;

FIG. 7 is an isometric view of an inspection unit of the sealing apparatus from FIG. 1;

FIG. 8 is a top view of a front side of the inspection unit from FIG. 7;

FIG. 9A is a view of a container;

FIG. 9B is a view of a stopper;

FIG. 9C is a view of a closure cap;

FIG. 10 is a view of a container with a placed closure cap;

FIG. 11 is a top view of a front side of the sealing apparatus from FIG. 1 in a first configuration with a received container and without the inspection unit;

FIG. 12 is a top view of a front side of the sealing apparatus from FIG. 1 in a second configuration with a container held at a crimping position and without the inspection unit;

FIG. 13 is the view from FIG. 12 with the inspection unit;

FIG. 14 is an isometric view of an embodiment of a barrier system; and

FIG. 15 is an isometric view of an embodiment of a method.

### DETAILED DESCRIPTION

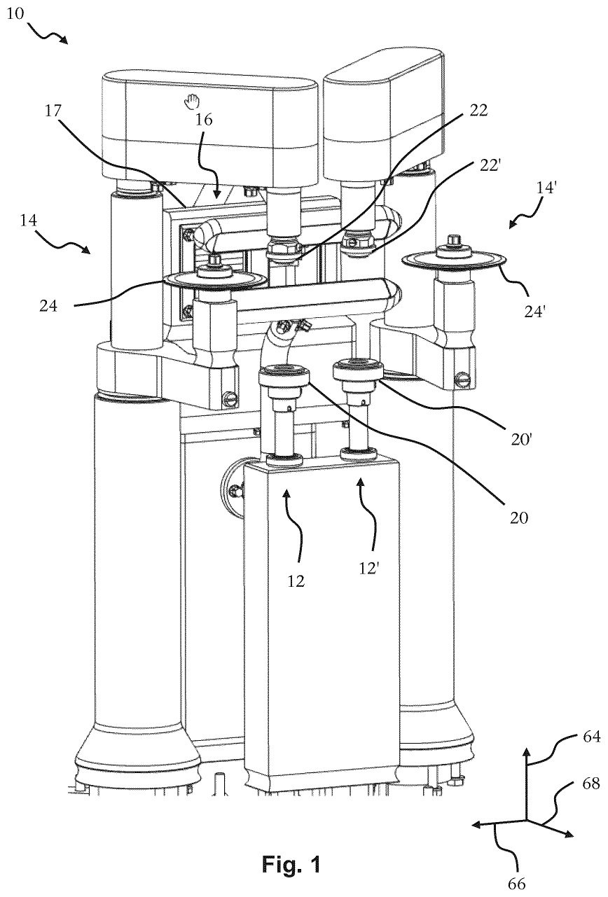

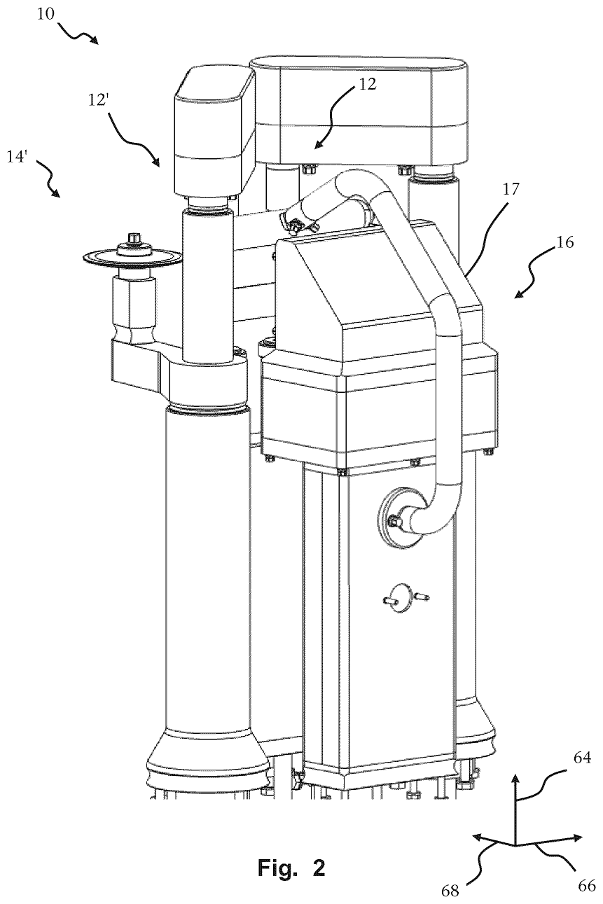

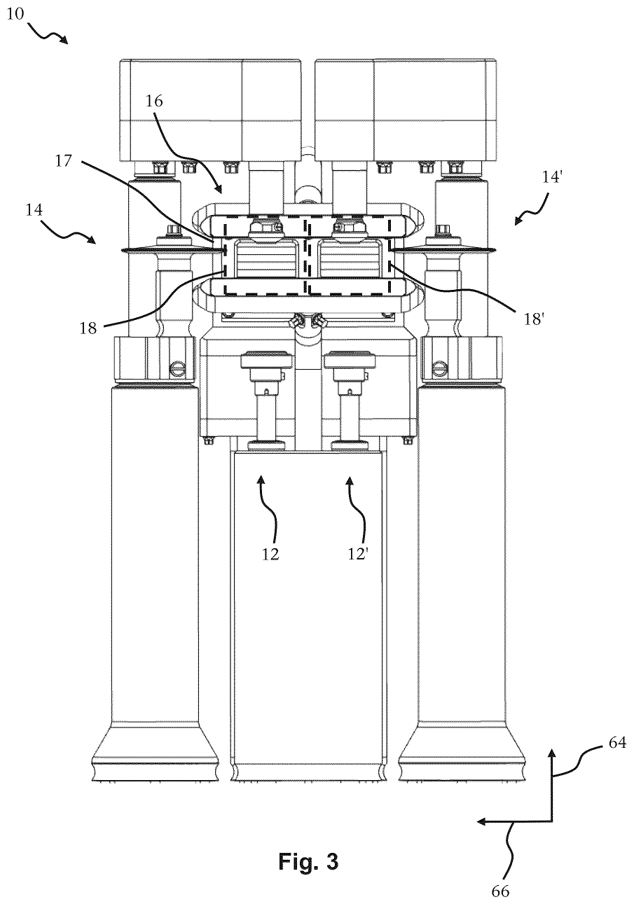

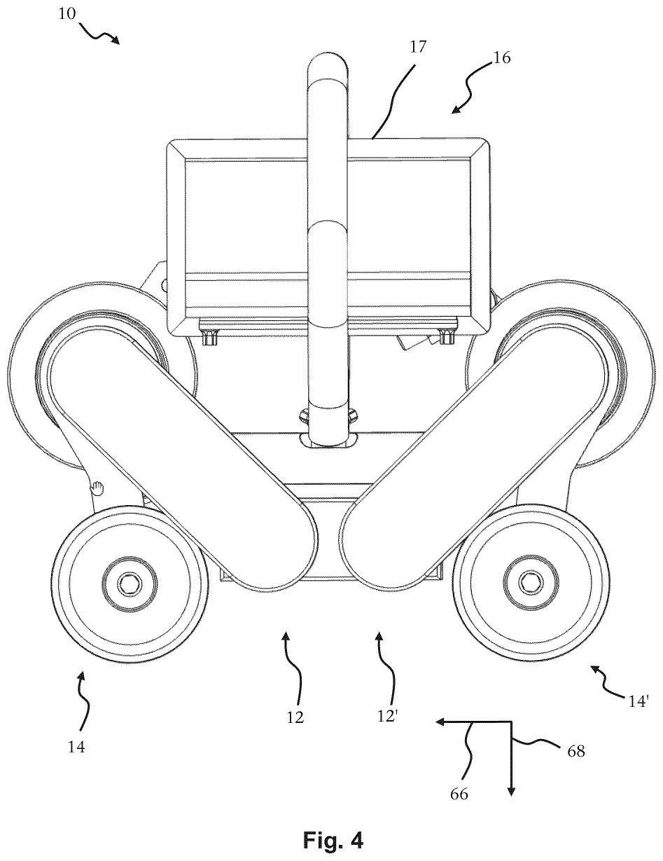

FIGS. 1 to 4 show an embodiment of a sealing apparatus, designated in its entirety by reference numeral 10. The sealing apparatus 10 serves to seal a container with a closure cap. The sealing apparatus 10 can be arranged in an environment with restricted access, in particular in an isolator. The sealing apparatus 10 can in particular be part of a barrier system.

With regard to the sealing apparatus 10, a vertical direction 64, a first direction 66 and a second direction 68 are defined. The first direction 66 and the second direction 68 run perpendicular to the vertical direction 64. The first direction 66 and the second direction 68 thus run horizontally. The first direction 66 runs perpendicular to the second direction 68.

The sealing apparatus 10 serves to seal containers with a closure cap. The sealing apparatus 10 comprises a first holding unit 12, a first crimping unit 14 and an optical inspection unit 16. The first holding unit 12 and the first crimping unit 14 serve to seal a first container with a first closure cap. The optical inspection unit 16 serves to inspect one or more properties of the first container and/or the first closure cap. The optical inspection unit 16 can also inspect one or more properties of a first stopper that may be arranged in an opening of the first container.

The first holding unit 12 is configured to hold the first container with the first closure cap at a first crimping position. The first crimping unit 14 is configured to crimp the first closure cap onto the first container at the crimping position. Through crimping, the closure cap is fastened to the container.

The first holding unit 12 comprises a first receiving element 20 and a first counter element 22. The first receiving element 20 serves to receive the first container. The first receiving element 20 and the first counter element 22 are spaced apart from one another in the vertical direction 64. The first counter element 22 is arranged above the first receiving element 20 in the vertical direction 64. The first counter element 22 is arranged above the first crimping position in the vertical direction 64. The first receiving element 20 is arranged below the first crimping position in the vertical direction 64.

The first container can be arranged between the first receiving element 20 and the first counter element 22 at the first crimping position. In particular, the first container with the first closure cap can be held between the first receiving element 20 and the first counter element 22 at the crimping position. For this purpose, the first receiving element 20 and/or the first counter element 22 may be configured to be movable in the vertical direction 64.

Furthermore, the first holding unit 12 is configured to rotate the first container about a vertical axis at the first crimping position. In particular, the first holding unit 12 can rotate the first container about the vertical axis while the first crimping unit 14 crimps the first closure cap onto the first container. For this purpose, the first receiving element 20 and/or the first counter element 22 may be configured to be rotatable about the vertical axis.

The first crimping unit 14 comprises a first crimping element 24 for crimping. The first crimping element 24 may in particular be a crimping disk. The first crimping element 24 can be pressed against the first closure cap for crimping while the first container with the first closure cap is held at the first crimping position and rotated about the vertical axis.

The first crimping element 24 is movable between a standby position and a working position. In the working position, the first crimping element 24 is pressed against the first closure cap for crimping. In the standby position, the first crimping element 24 is arranged at a distance from the first closure cap. In other words, the first crimping element 24 is arranged closer to the first crimping position in the working position than in the standby position. In FIGS. 1 to 4, the first crimping element 24 is shown in the standby position. In the standby position, the first crimping element 24 is preferably spaced in the first direction 66 from the first crimping position, in particular from the first receiving element 20 and the first counter element 22. In particular, the first crimping element 24 is arranged in the first direction 66 next to the first crimping position.

The optical inspection unit 16 is configured to optically inspect the first closure cap and/or the first container and/or the first stopper, preferably during the sealing process. In particular, the inspection unit inspects one or more properties of the first container and/or the first closure cap and/or the first stopper.

For optical inspection, the inspection unit 16 comprises a camera system 17. The camera system 17 is in particular configured to detect a detection area 18 in space. The first crimping position is arranged within the detection area 18. In other words, the first container and the first closure cap are arranged within the detection area 18 when they are positioned at the first crimping position.

The camera system 17 is arranged at essentially the same height as the first crimping position in the vertical direction 64. The camera system 17 is spaced in the second direction 68 from the first crimping position, in particular from the first receiving element 20 and the first counter element 22. In particular, the camera system 17 is arranged in the second direction 68 laterally next to the first crimping position.

The sealing apparatus 10 can in particular process or seal two containers simultaneously. For this purpose, the sealing apparatus 10 can comprise a second holding unit 12′ and a second crimping unit 14′. In particular, the second holding unit 12′ and the second crimping unit 14′ can serve to seal a second container with a second closure cap. The optical inspection unit 16 can furthermore serve to inspect the sealing process of the first container and the second container. A second stopper can be arranged in an opening of the second container. The second container can be sealed at a second crimping position by means of the second holding unit 12′ and the second crimping unit 14′. In particular, the second holding unit 12′ can hold the second container at the second crimping position, and the second crimping unit 14′ can crimp the second closure cap onto the second container at the second crimping position. The second crimping position is preferably spaced from the first crimping position in the first direction 66. In particular, the second crimping position can be arranged next to the first crimping position in the first direction 66.

The second holding unit 12′ and the second crimping unit 14′ have essentially the same structure and the same function as the first holding unit 12 and the first crimping unit 14. In particular, the second holding unit 12′ comprises a second receiving element 20′ and a second counter element 22′. Furthermore, the second crimping unit 14′ comprises a second crimping element 24′.

The inspection unit 16 can in particular inspect the respective containers and/or closure caps and/or stoppers at both crimping positions. In particular, the inspection unit 16 can optically inspect both closure caps and/or both containers during the sealing process. The camera system 17 can detect the first container at the first crimping position in the first detection area 18. The camera system 17 can detect the second container at the second crimping position in a second detection area 18′. Alternatively, the camera system 17 can also detect both containers at both crimping positions in a common detection area 18.

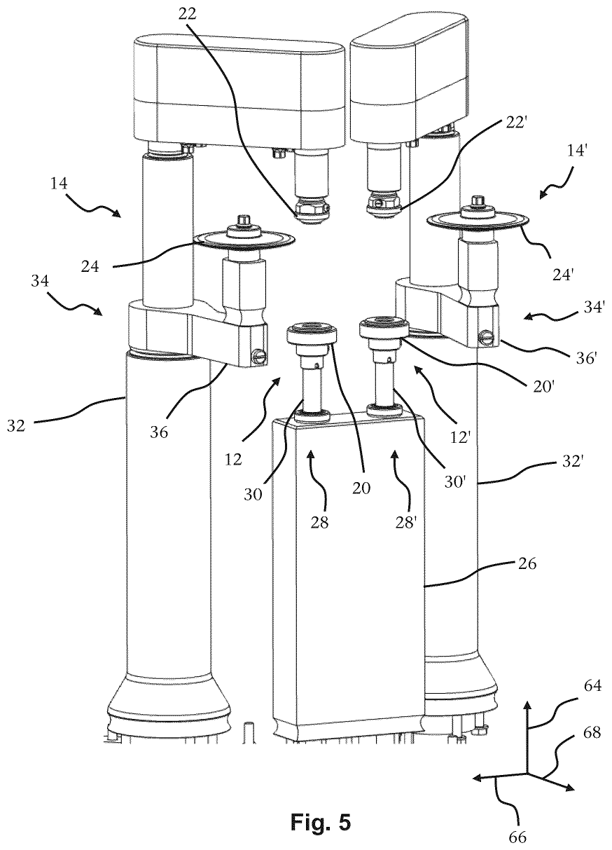

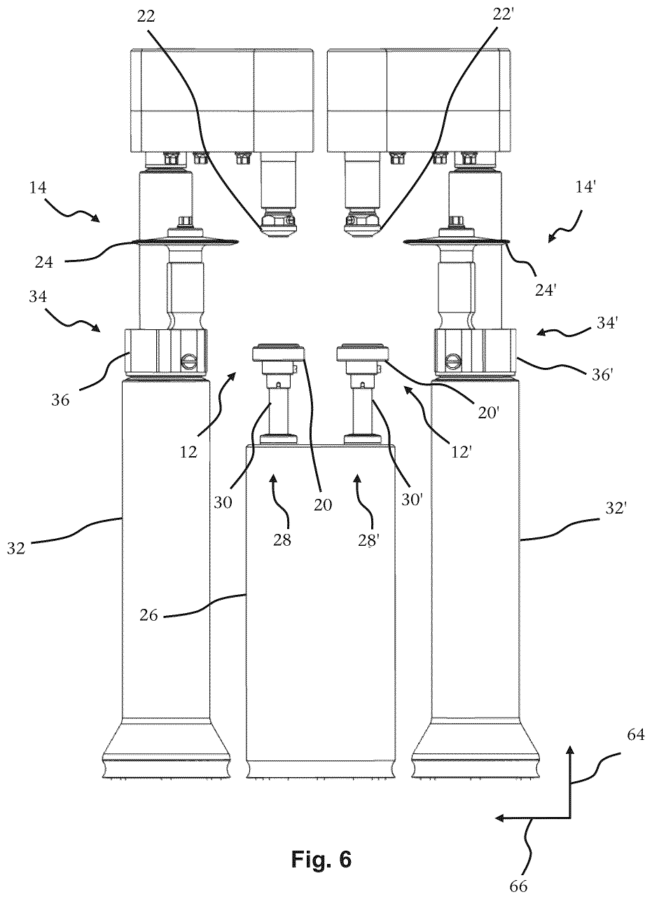

The holding unit 12 and the crimping unit 14 as well as their arrangement in the sealing apparatus 10 are shown in FIGS. 5 and 6.

The sealing apparatus 10 comprises a first support structure 26. The first receiving element 20 is arranged on the first support structure 26. In particular, the first support structure 26 carries the first receiving element 20. The first receiving element 20 is mounted on the first support structure 26 to be movable in the vertical direction 64. As a result, the first receiving element 20 can be moved relative to the first counter element 22. In particular, the first receiving element 20 can be moved relative to the first counter element 22 between a first arrangement and a second arrangement. In the second arrangement, the first receiving element 20 is arranged closer to the first counter element 22 than in the first arrangement. In the first arrangement, the first receiving element 20 and the first counter element 22 are spaced apart such that the first container can be received in the first receiving element 20 and the first closure cap can be placed on it. Alternatively, the closure cap may already be placed on the container before the container is arranged or received in the receiving element 20. In this case, the first receiving element 20 and the first counter element 22 are spaced apart in the first arrangement such that the first container with the closure cap placed on it can be received in the first receiving element 20. In the second arrangement, the first receiving element 20 and the first counter element 22 are moved so close together that the first container in the second arrangement can be held between the first receiving element 20 and the first counter element 22 at the first crimping position. Furthermore, the first receiving element 20 is also rotatably mounted about a vertical axis on the first support structure 26.

The first holding unit 12 can comprise a drive unit 28. The drive unit 28 can be configured to move the first receiving element 20 in the vertical direction 64 and/or to rotate it about the vertical axis. The first holding unit 12 can comprise a first rod 30. The first receiving element 20 is mounted on the first support structure 26 via the first rod 30 so as to be movable in the vertical direction 64 and/or rotatable about the vertical axis. The first receiving element 20 is arranged on a first, upper end of the first rod 30. A second, lower end of the first rod 30 is mounted on the first support structure 26 to be movable in the vertical direction 64 and/or rotatable about the vertical axis. The drive unit 28 can be configured to move the first rod 30 in the vertical direction 64 and/or to rotate the first rod 30 about the vertical axis.

The sealing apparatus 10 comprises a second support structure 32. The first counter element 22 is arranged on the second support structure 32. In particular, the second support structure 32 carries the first counter element 22. The first counter element 22 can be rotatably mounted about a vertical axis on the support structure 32. Furthermore, the first crimping element 24 can also be arranged on the second support structure 32. In particular, the first crimping element 24 can be pivotably mounted about a vertical axis on the second support structure 32. In particular, the first crimping element 24 can be pivoted between the standby position and the working position.

The first crimping unit 14 can comprise a drive unit 34. The drive unit 34 can be configured to pivot the first crimping element 24 between the standby position and the working position. The first crimping unit 14 can comprise a first arm 36. The first crimping element 24 is in particular pivotably mounted on the second support structure 32 via the first arm 36. The first crimping element 24 is arranged on a first end of the first arm 36, in particular rotatably mounted about a vertical axis. A second end of the first arm 36 is mounted on the second support structure 32 rotatably about a vertical axis. The drive unit 34 can be configured to rotate the first arm 36 about the vertical axis.

In particular, the second holding unit 12′ can comprise a drive unit 28′ for moving the second receiving element 20′ and a second rod 30′. The second receiving element 20′ and the second rod 30′ can be arranged or mounted on the first support structure 26. The second counter element 22′ can be arranged or mounted on a further support structure 32′. Furthermore, the second crimping unit 14′ comprises a drive unit 34′ for moving the second crimping element 24′ and a second arm 36′. The second crimping element 24′ and the second arm 36′ can be arranged or mounted on the further support structure 32′.

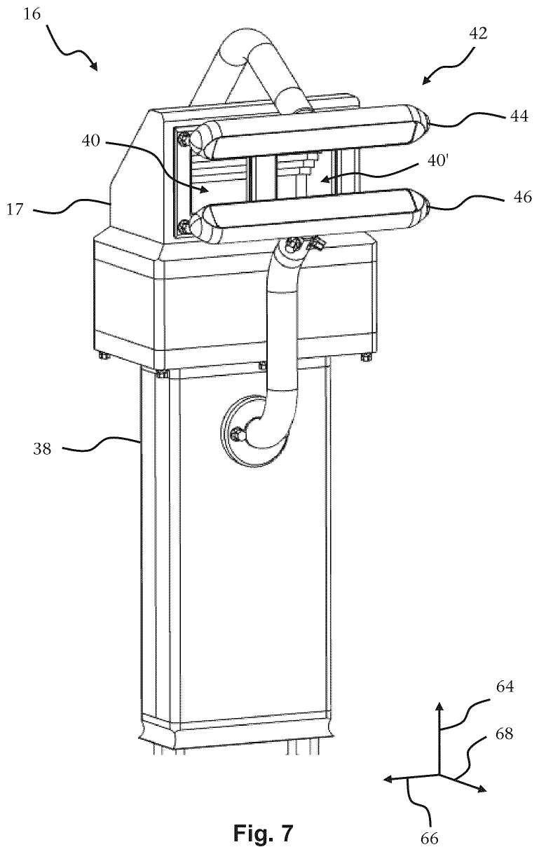

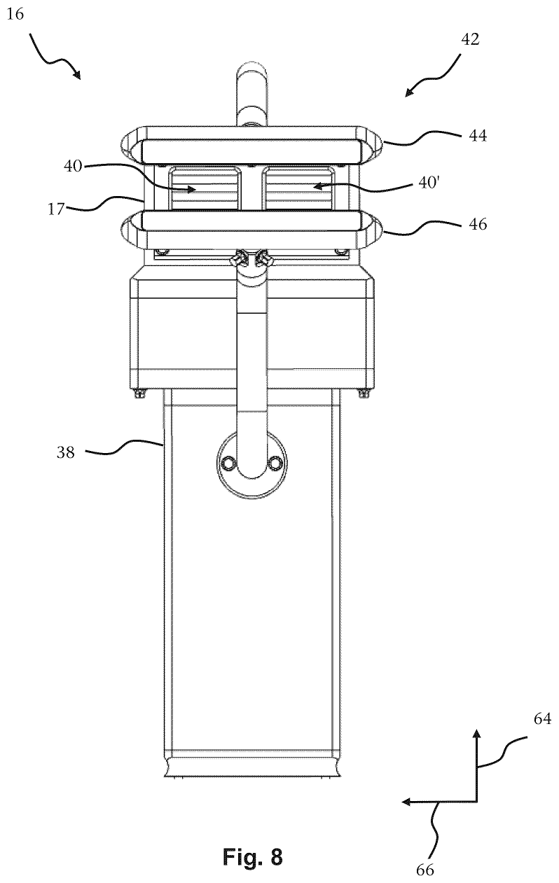

The inspection unit 16 is shown in FIGS. 7 and 8. The inspection unit 16 comprises a base body 38. The camera system 17 is arranged in the vertical direction 64 in an upper part of the base body 38.

The camera system 17 comprises a first camera 40. The first camera 40 is directed toward the first crimping position. The first camera 40 is arranged in the vertical direction 64 essentially at the same height as the first crimping position. A viewing direction of the first camera 40 preferably runs parallel to the second direction 68.

The first camera 40 is configured to capture an image of the first detection area 18. In other words, the first camera 40 is configured to detect or capture one or more images of the first closure cap and/or the first container at the first crimping position. The inspection unit 16 can then inspect one or more properties of the first container and/or the first closure cap and/or the first stopper based on the one or more images.

The camera system 17 may further comprise a second camera 40′. The second camera 40′ is arranged next to the first camera 40 in the first direction 66. The second camera 40′ is directed toward the second crimping position. The second camera 40′ is arranged in the vertical direction 64 essentially at the same height as the second crimping position. A viewing direction of the second camera 40′ preferably runs parallel to the second direction 68.

The second camera 40′ is configured to capture an image of the second detection area 18′. In other words, the second camera 40′ is configured to detect or capture one or more images of the second closure cap and/or the second container at the second crimping position. The inspection unit 16 can then inspect one or more properties of the second container and/or the second closure cap and/or the second stopper based on the one or more images.

Alternatively, the camera system 17 may also comprise only one camera 40 that is capable of detecting both detection areas 18, 18′.

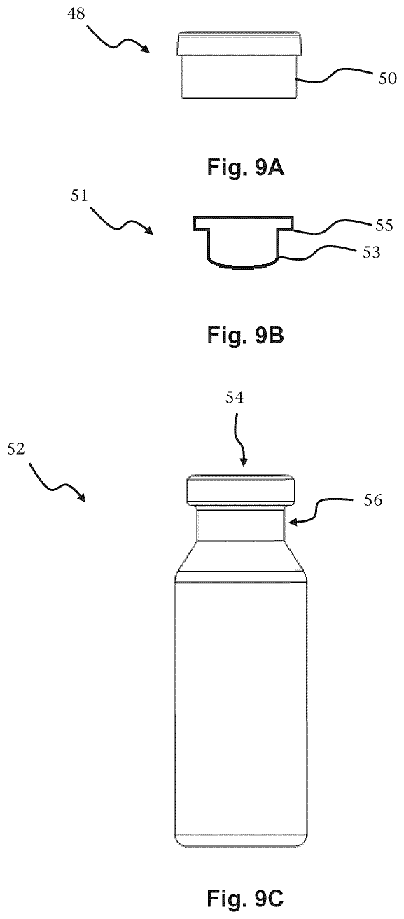

FIG. 9A shows a closure cap 48. The closure cap 48 may in particular be a crimp cap. The closure cap 48 is sleeve-shaped, with one end being closed. The closure cap 48 comprises a circumferential wall 50.

FIG. 9B shows a stopper 51. The stopper comprises a projection 53. The stopper may comprise a lip 55 surrounding the projection 53. The stopper may be a rubber stopper.

FIG. 9C shows a container 52. The container 52 may be a pharmaceutical or cosmetic container. The container 52 may in particular be an ampoule or a vial. The container 52 comprises an opening 54. The container 52 may be filled with a pharmaceutical or cosmetic product. The container comprises a crimping region 56.

The crimping region 56 preferably extends circumferentially around the container 52. The crimping region may comprise, for example, a recess, a depression, or a groove. The crimping region 56 may be arranged below the opening 54.

The closure cap 48 is preferably crimped in the crimping region 56 of the container 52. When the closure cap 48 is placed onto the container 52, the closure cap 48 can extend from the opening 54 to the crimping region 56. By crimping, the closure cap 48 is pressed against or into the crimping region 56 in the area of the crimping region 56. In particular, a lower edge of the wall 50 may be pressed into the crimping region 56. In this way, the closure cap 48 is held on the container 52.

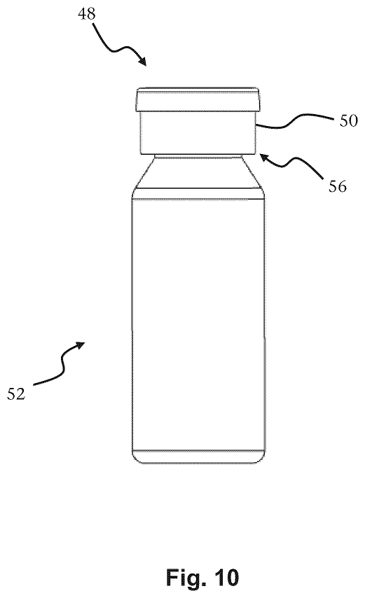

FIG. 10 shows an arrangement in which the closure cap 48 is arranged on the container 52, in particular placed thereon. The closure cap 48 is arranged over the opening 54. The closure cap 48 completely covers the opening 54 and extends to the crimping region 56. The circumferential wall 50 surrounds the crimping region 56. In other words, the wall 50 extends circumferentially around the crimping region 56. The stopper 51 can be arranged or inserted in the opening 54. The projection 53 can extend into the opening 54. The lip 55 can rest circumferentially on the edge of the opening 54. The stopper 51 is then also covered by the closure cap 48.

When the closure cap 48 is arranged on the container 52, the closure cap 48 can be crimped in the crimping region 56 of the container 52. In particular, the wall 50 can be pressed circumferentially into or against the crimping region 56.

In particular, the container 52 with the placed closure cap 48 can be arranged at the first or second crimping position in order to seal the container 52 by means of the respective holding device 12, 12′ and crimping device 14, 14′. In the following, the sealing of the container 52 with the closure cap 48 at the first crimping position 62 is described. The container 52 is hereinafter referred to as the first container. The closure cap 48 is hereinafter referred to as the first closure cap. The sealing of a second container 52′ with a second closure cap 48′ at the second crimping position 62′ can be carried out accordingly.

In order to arrange each container 52, 52′ at the respective crimping position 62, 62′, each receiving element 20, 20′ and each counter-element 22, 22′ are arranged in a first arrangement 58. In FIGS. 1 to 6 and 11, the receiving elements 20, 20′ and the counter-elements 22, 22′ are arranged in the first arrangement 58.

In the first arrangement 58, the receiving element 20, 20′ and the corresponding counter-element 22, 22′ are spaced apart from each other so far that the respective container 52, 52′ can be placed in the receiving element 20, 20′ and the respective closure cap 48, 48′ can be placed on the respective container 52, 52′. For this purpose, the respective drive device 28, 28′ can move the receiving element 20, 20′ and/or the counter-element 22, 22′ relative to one another accordingly. In particular, the drive device 28, 28′ can move the receiving element 20, 20′ away from the counter-element 22, 22′ in the vertical direction. In this way, the respective receiving element 20, 20′ and the corresponding counter-element 22, 22′ can be brought into the first arrangement 58.

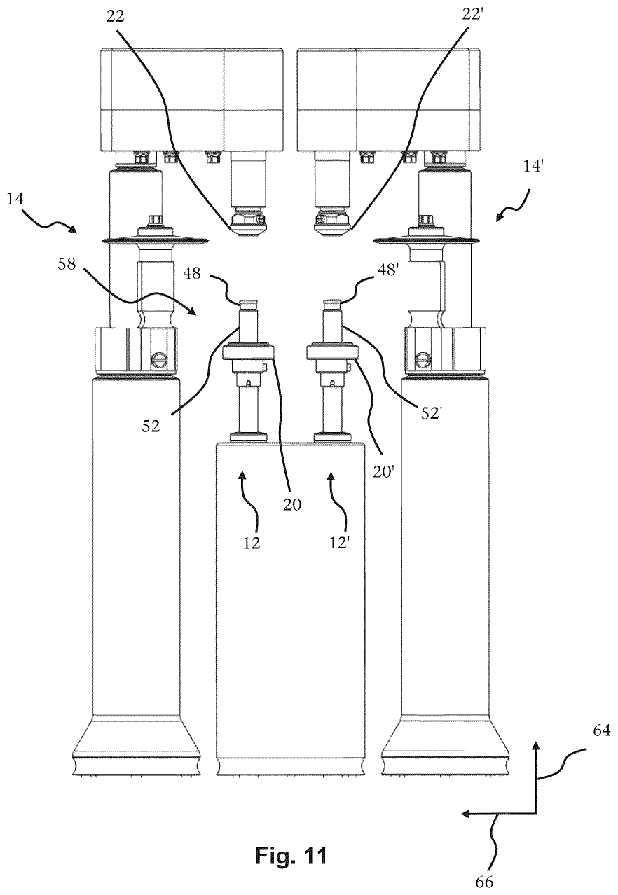

When the respective receiving element 20, 20′ and the corresponding counter-element 22, 22′ are arranged in the first arrangement 58, the respective container 52, 52′ can be placed in or on the respective receiving element 20, 20′ and the respective closure cap 48, 48′ can be placed on the container 52, 52′. This condition is shown in FIG. 11.

Each container 52, 52′ can be arranged in or on the respective receiving element 20, 20′, in particular by means of a handling device. Furthermore, the respective closure cap 48, 48′ can then be placed onto the respective container 52, 52′ by means of a handling device.

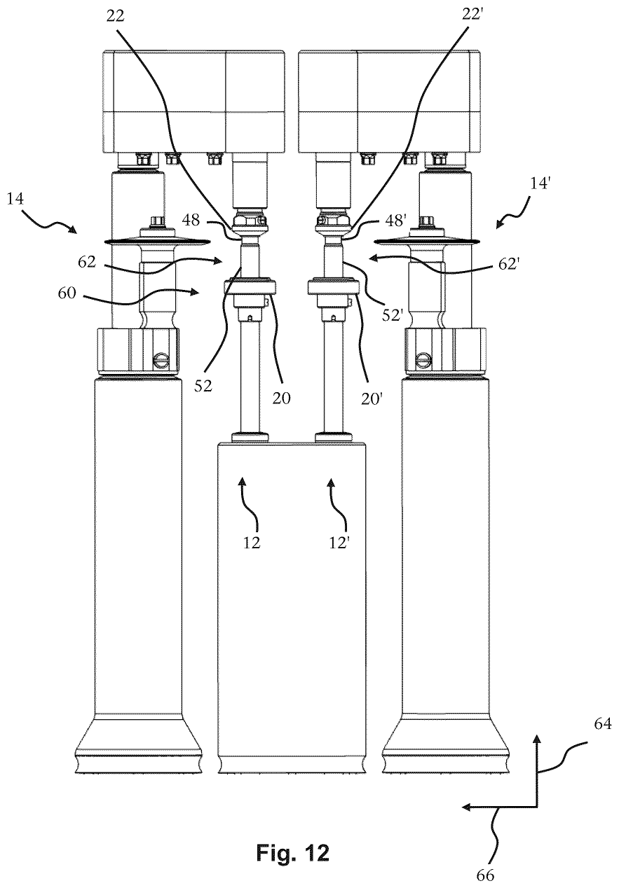

In order to hold each container 52, 52′ at the respective crimping position 62, each receiving element 20, 20′ and each counter-element 22, 22′ can be brought into the second arrangement 60. In FIG. 12, each receiving element 20, 20′ and each counter-element 22, 22′ are arranged in the second arrangement 60. In the second arrangement 60, the receiving element 20, 20′ and the corresponding counter-element 22, 22′ are arranged so close to one another that the respective container 52, 52′ and the respective closure cap 48, 48′ are held between the receiving element 20, 20′ and the corresponding counter-element 22, 22′. In particular, the counter-element 22, 22′ contacts the respective closure cap 48, 48′ and presses it against the respective container 52, 52′, especially in the direction of the opening 54. For this purpose, the respective drive device 28, 28′ can move the receiving element 20, 20′ and/or the counter-element 22, 22′ relative to each other accordingly. In particular, the drive device 28, 28′ can move the receiving element 20, 20′ toward the counter-element 22, 22′ in the vertical direction. In this way, the receiving element 20 and the corresponding counter-element 22, 22′ can be brought into the second arrangement 60.

When the respective receiving element 20, 20′ and the corresponding counter-element 22, 22′ are arranged in the second arrangement 60, the respective container 52, 52′ and the respective closure cap 48, 48′ are held at the respective crimping position 62, 62′. This is shown in FIG. 12.

To crimp the respective closure cap 48, 48′, the corresponding crimping element 24, 24′ can then be moved into the working position. As a result, the respective crimping element 24, 24′ is pressed against the wall 50 of the respective closure cap 48, 48′. The wall 50 is thereby pressed into the crimping region 56 of the respective container 52, 52′. During crimping, the respective holding device 12, 12′ then rotates the container 52, 52′ together with the respective closure element 48, 48′. As a result, the wall 50 is pressed circumferentially into the crimping region 56. This way, the respective closure cap 48, 48′ is crimped circumferentially onto the corresponding container 52, 52′.

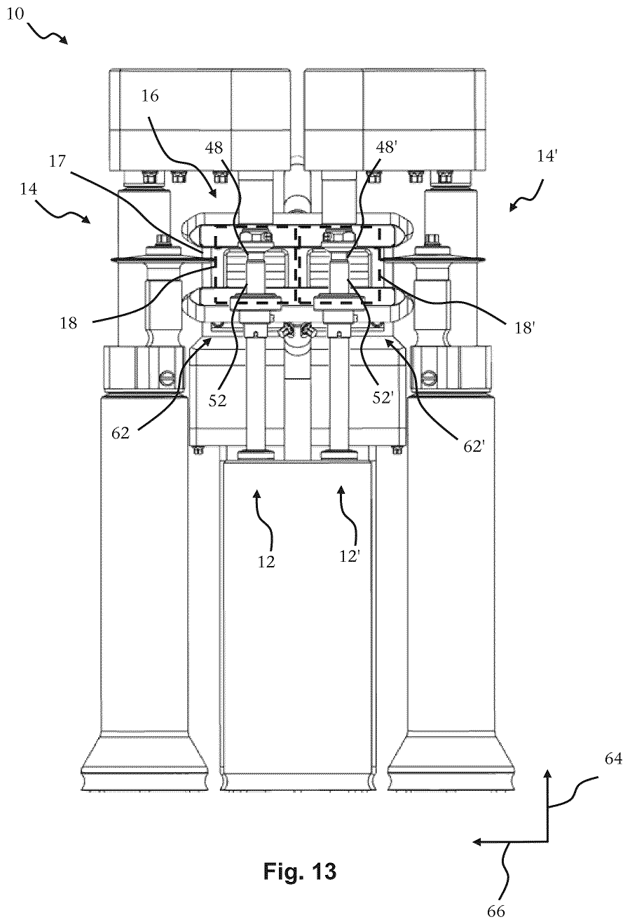

As previously described, each camera 40, 40′ is configured to capture one or more images of the respective container 52, 52′ and the respective closure cap 48, 48′ at the corresponding crimping position 62, 62′. The first crimping position 62 is located in the detection area 18 of the first camera 40. The second crimping position 62′ is located in the detection area 18′ of the second camera 40′. This is shown in FIG. 13.

Based on the captured images, the inspection unit 16 can, for example, check the arrangement of the closure cap 48, 48′ and/or the container 52, 52′ at the respective crimping position 62, 62′. In particular, it can be checked whether the container 52, 52′ and/or the closure cap 48, 48′ are arranged at the respective crimping position 62, 62′. Specifically, the inspection unit 16 can determine based on the one or more images whether the container and/or the closure cap are arranged at the crimping position, preferably in a predetermined arrangement. Furthermore, it can also be checked whether the respective closure cap 48, 48′ is correctly arranged on the container 52, 52′. This check can be performed before, during, and after crimping.

Based on the captured images, the inspection unit 16 can also check the crimping quality of the crimping. In particular, the inspection unit 16 can determine based on the captured images whether the respective container 52, 52′ is properly sealed with the respective closure cap 48, 48′ and/or whether the crimping is defect-free. For example, it can be determined whether the closure cap 48, 48′ is correctly arranged on the container 52, 52′ and whether the crimping is circumferentially uniform.

Furthermore, each camera 40, 40′ can also capture multiple images in succession while the respective container 52, 52′ and the respective closure cap 48, 48′ are being rotated during crimping. The images then particularly depict the entire circumferential crimping. Based on these images, it can then be determined whether the crimping is circumferentially uniform.

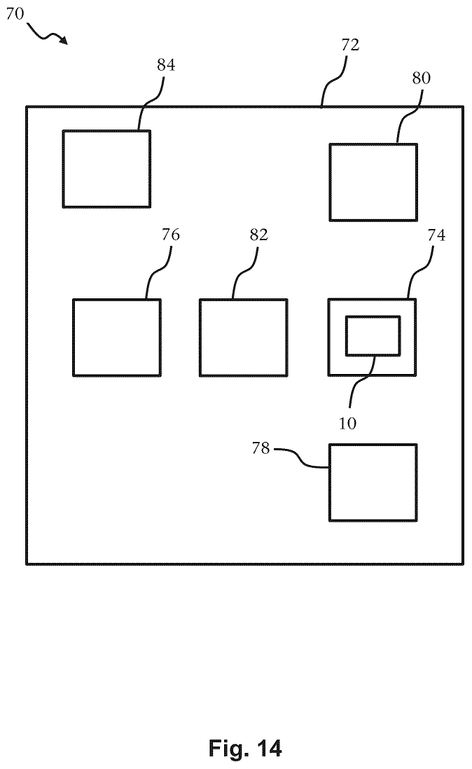

FIG. 14 shows an embodiment of a barrier system, designated in its entirety with reference numeral 70. The barrier system 70 comprises an environment 72 with restricted access. The barrier system 70 may be an isolator system. The environment 72 with restricted access may be an isolator.

The barrier system 70 comprises the sealing device 10, which is described in connection with FIGS. 1 to 13. The sealing device 10 is arranged in the environment 72 with restricted access.

The barrier system 70 may comprise a sealing station 74 within the restricted access environment 72, wherein the sealing device 10 is part of the sealing station 74. In the sealing station 74, the containers 52 can be sealed with the closure caps 48.

The barrier system 70 may further comprise a feed device 76, by means of which the closure caps 48 can be supplied and provided within the environment 72 with restricted access.

The barrier system 70 may further comprise a first station 78. In the first station 78, the containers 52 are provided without closure caps. The containers 52 are preferably filled with a pharmaceutical or cosmetic product. The first station 78 may be a filling station in which the containers are filled with the pharmaceutical or cosmetic product. The first station 78 may also be a stoppering station in which a stopper is inserted into the opening 54 of the filled containers 52. The first station 78 may also be a transfer station at which filled and in particular stoppered containers can be arranged or transferred.

The barrier system 70 may further comprise a second station 80. In the second station 80, containers 52 sealed with a closure cap 48 are arranged. The second station 80 may be, for example, a transfer station at which the sealed containers can be arranged or transferred.

The barrier system 70 may further comprise one or more handling devices 82. The handling devices 82 may be configured to handle the containers 52 and/or the closure caps 48. For example, one of the handling devices 82 may be configured to transfer the containers 52 from the first station 78 to the sealing station. In particular, this handling device 82 may place the containers 52 in the receiving element 20. Furthermore, one of the handling devices 82 may be configured to transfer the closure caps 48 from the feed device 76 to the sealing station. In particular, this handling device 82 may place the closure caps 48 onto the containers 52 in the sealing station 74, for example when they are placed in the receiving element 20. Alternatively, the closure caps 48 may already be placed onto the containers 52 prior to the sealing station 74. Furthermore, one of the handling devices 82 may be configured to transfer the containers 52 sealed with a closure cap 48 from the sealing station to the second station 80.

The barrier system 70 may further comprise a control unit 84. The control unit 84 may be configured to control the handling devices 82. Furthermore, the control unit 84 may also be configured to control the sealing device 10. In particular, the control unit 84 may control, for example, the holding device 12 and the crimping device 14.

In particular, the control unit 84 may control the sealing device and/or the handling devices based on the optical inspection performed by the inspection unit 16. For example, the control unit 84 may control the sealing device 10 based on the optical inspection in such a way that the sealing device 10 only performs crimping for closure caps that are correctly placed on a container. Furthermore, the control unit 84 may cause a checked container for which the inspection has determined that it is incorrectly sealed to be transferred by one of the handling devices 84 to an ejection device within the environment 72, in order to eject the incorrectly sealed container or collect it in a collection container.

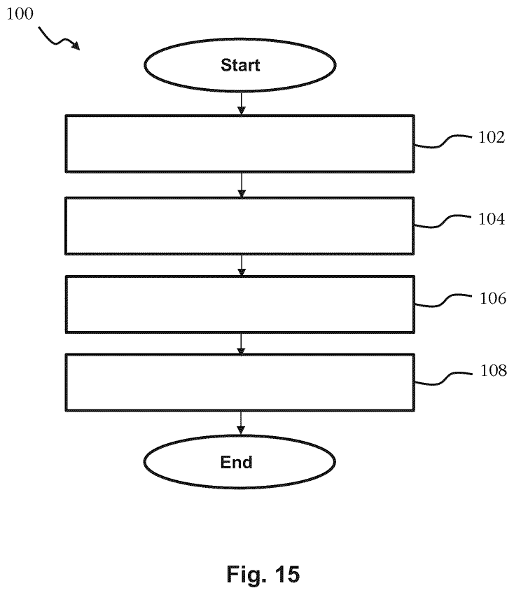

FIG. 15 shows an embodiment of a method, designated in its entirety with reference numeral 100. The method 100 serves for sealing a container 52 with a closure cap 48. The container 52 may be a pharmaceutical or cosmetic container. The container 52 may in particular be an ampoule or a vial. The closure cap 48 may in particular be a crimp cap. A stopper 51 may be arranged or inserted in the opening 54 of the container 52. The closure cap 48 may be arranged or placed on the container 52. The method 100 can be carried out using the sealing device 10 from FIGS. 1 to 13. The method 100 can in particular be carried out in the barrier system 70 from FIG. 14.

In a first step 102 of the method 100, the container 52 is held at a crimping position 62 by means of the holding device 12 of the sealing device 10. In particular, one container 52, 52′ may be held at the respective crimping position 62, 62′ by the corresponding holding device 12, 12′.

In a further optional step 104 of the method 100, the container 52 may be rotated about a vertical axis at the crimping position 62 by means of the holding device 12.

In a further step 106 of the method 100, the closure cap 48 is crimped onto the container 52 at the crimping position 62 by means of the crimping device 14 of the sealing device 10. In particular, one closure cap 48, 48′ may be crimped onto the respective container 52, 52′ at the respective crimping position 62, 62′ by means of the corresponding crimping device 14, 14′.

The holding device 12 may rotate the container 52 and the closure cap 48 about the vertical axis during crimping. In particular, each holding device 12, 12′ may rotate the respective container 52, 52′ and the corresponding closure cap 48, 48′ about the respective vertical axis during crimping.

In a further step 108 of the method 100, one or more properties of the container 52 and/or the closure cap 48 and/or the stopper 51 at the crimping position 62 are inspected by means of the optical inspection unit 16 of the sealing device, wherein the inspection unit comprises the camera system 17.

The holding device 12 may rotate the container 52 and the closure cap 48 about the vertical axis while the inspection unit 16 inspects one or more properties of the container 52 and/or the closure cap 48 at the crimping position 62.

In particular, the camera system 17 may comprise one or more cameras 40, 40′, wherein the cameras 40, 40′ capture one or more images of the closure caps 48, 48′ and/or the container 52, 52′ at the respective crimping position 62, 62′, wherein the inspection unit 16 inspects the sealing of the respective container 52, 52′ based on the one or more images.

Based on the captured images, the inspection unit 16 can, for example, inspect the arrangement of the closure cap 48, 48′ and/or the container 52, 52′ at the respective crimping position 62, 62′. Based on the captured images, the inspection unit 16 can also inspect the crimping quality of the crimping.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance, “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A sealing apparatus for sealing a container with a closure cap, the sealing apparatus comprises a holding unit and a crimping unit, the holding unit is configured to hold the container at a crimping position, and the crimping unit is configured to crimp the closure cap onto the container at the crimping position, wherein the sealing apparatus further comprises an optical inspection unit which is configured to inspect one or more properties of at least one of the container or the closure cap at the crimping position, and the optical inspection unit comprises a camera system.

2. The sealing apparatus according to claim 1, wherein the optical inspection unit is further configured to inspect one or more properties of a stopper which is arranged in an opening of the container.

3. The sealing apparatus according to claim 1, wherein the holding unit is configured to rotate the container about a vertical axis at the crimping position, while the crimping unit crimps the closure cap onto the container and the optical inspection unit inspects the one or more properties of at least one of the container or the closure cap at the crimping position.

4. The sealing apparatus according to claim 3, wherein a camera of the camera system is configured to sequentially capture a plurality of images of at least one of the closure cap or the container at the crimping position while the holding unit rotates the container about the vertical axis at the crimping position, the optical inspection unit is configured to inspect, on the basis of the plurality of images, the one or more properties of at least one of the container, the closure cap, or of the stopper, and the optical inspection unit is configured to determine, on the basis of the plurality of images, the crimping quality of the crimping.

5. The sealing apparatus according to claim 1, wherein the holding unit comprises a receiving element for receiving the container and a counter element, the container is arrangeable between the receiving element and the counter element at the crimping position, and the receiving element and the counter element are spaced apart from each other in a vertical direction.

6. The sealing apparatus according to claim 5, wherein the holding unit further comprises a drive unit for at least one of rotational or translational movement of at least one of the receiving element or the counter element.

7. The sealing apparatus according to claim 6, wherein the drive unit is configured to move the receiving element and the counter element relative to each other between a first arrangement and a second arrangement, the container is receivable in the receiving element in the first arrangement, and the container is retainable between the receiving element and the counter element at the crimping position in the second arrangement.

8. The sealing apparatus according to claim 6, wherein the drive unit is configured to rotate at least one of the receiving element or the counter element about a vertical axis, while the crimping unit crimps the closure cap onto the container.

9. The sealing apparatus according to claim 1, wherein the crimping unit comprises a crimping element, the crimping element is movable into a working position in which the crimping element is pressed against the closure cap.

10. The sealing apparatus according to claim 1, wherein the optical inspection unit is configured to inspect the arrangement of at least one of the closure cap, the container, or the stopper at the crimping position.

11. The sealing apparatus according to claim 1, wherein the optical inspection unit is configured to inspect the configuration of at least one of the closure cap, the container, or the stopper at the crimping position.

12. The sealing apparatus according to claim 1, wherein the camera system comprises one or more cameras which are configured to capture one or more images of at least one of the closure cap, the container, or the stopper at the crimping position, and the optical inspection unit is configured to inspect, on the basis of the one or more images, the one or more properties of at least one of the container, the closure cap, or of the stopper.

13. The sealing apparatus according to claim 12, wherein the optical inspection unit is configured to determine, on the basis of the one or more images, whether at least one of the container, the closure cap, or the stopper are arranged at the crimping position.

14. The sealing apparatus according to claim 12, wherein the optical inspection unit is configured to determine, on the basis of the one or more images, whether the configuration of at least one of the closure cap, the container, or the stopper corresponds to a predetermined configuration, and the optical inspection unit is configured to determine the crimping quality of the crimping on the basis of the one or more image.

15. The sealing apparatus according to claim 1, wherein the camera system is arranged laterally next to the crimping position.

16. The sealing apparatus according to claim 1, wherein the sealing apparatus comprises a plurality of holding units and a plurality of crimping units, each holding unit is configured to hold one container at a respective crimping position, each crimping unit is configured to crimp one closure cap onto the respective container at the respective crimping position, and the optical inspection unit is configured to inspect at least one of each container, each closure cap, or each stopper at the respective crimping position.

17. A barrier system, wherein the barrier system comprises an environment with restricted access, and the sealing apparatus according to claim 1, wherein the sealing apparatus is arranged in the environment with restricted access.

18. A method for sealing a container with a closure cap, the method comprising the steps of:
holding the container at a crimping position by means of a holding unit of a sealing apparatus;
crimping the closure cap onto the container at the crimping position by means of a crimping unit of the sealing apparatus; and
inspecting one or more properties of at least one of the container or the closure cap at the crimping position by means of an optical inspection unit of the sealing apparatus, wherein the optical inspection unit comprises a camera system.

19. The method according to claim 18, wherein in the step of inspecting, the optical inspection unit inspects one or more properties of a stopper which is arranged in an opening of the container.

20. The method according to claim 18, wherein the method further comprises the step of:
rotating the container at the crimping position about a vertical axis by means of the holding unit, while the crimping unit crimps the closure cap onto the container and the optical inspection unit inspects the one or more properties of at least one of the container or the closure cap at the crimping position.

21. The method according to claim 18, wherein the camera system comprises one or more cameras, the one or more cameras capture one or more images of at least one of the closure cap, the container, or the stopper at the crimping position, and the optical inspection unit inspects, on the basis of the one or more images, the one or more properties of at least one of the container, the closure cap, or the stopper.
